(19) United States
(12) Patent Application Publication
(10) Pub. No.: US 2005/0188783 A1
(43) Pub. Date: Sep. 1, 2005

(54) Energy conservation fly wheel with variable moment of inertia (ECF-VMI)

(76) Inventor: Velimir Mike Stanimirovic, Miami Beach, FL (US)

Correspondence Address: VELIMIR M. STANIMIROVIC, 415 - 76TH ST., APT. #8, MIAMI BEACH, FL, 33141, US

(21) Appl. No.: 10/788,647

(22) Filed: Feb. 28, 2004

(51) Int. Cl. G05G 1/00

(52) U.S. Cl. 74/574.2

(57) ABSTRACT

An energy conservation flywheel is utilizing variable moment of inertia and centrifugal forces to store kinetic energy. Flywheel is of a top shape (disk and a hollow shaft). Holes extend radially from the center of a disk. In these holes are placed sliding rods attached to an extension spring by cables, running thru hollow shaft, at one end while at other ends weights (steel spheres) are attached. Flywheel rotates in horizontal plane, held by roller bearings in a rigid frame. Flywheel rotates, after initial spin; centrifugal forces will cause weights to start moving outward hence increasing moment of inertia/decreasing a flywheel revolution. At the end of weights travel, an extension spring balances out and overcomes centrifugal forces thus pulls weights inward. Moment of inertia decreases, a flywheel rotation increases; weights centrifugal forces increase thus overcoming an extension spring force and sliding outward. Then continue to cycle for long time.

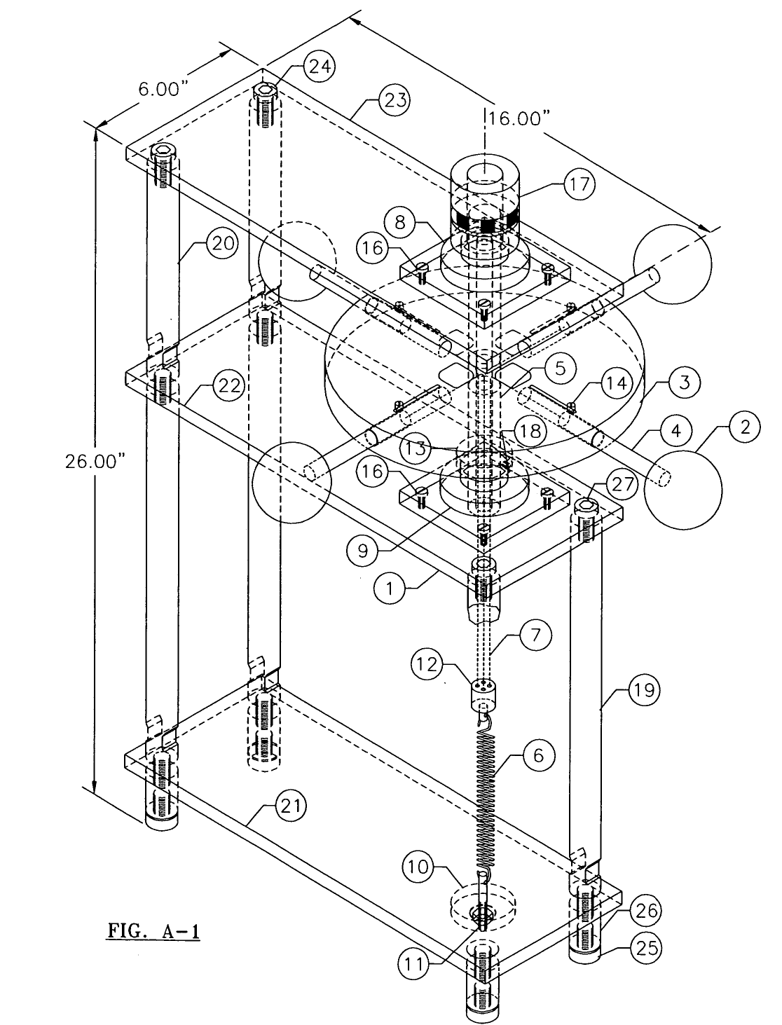

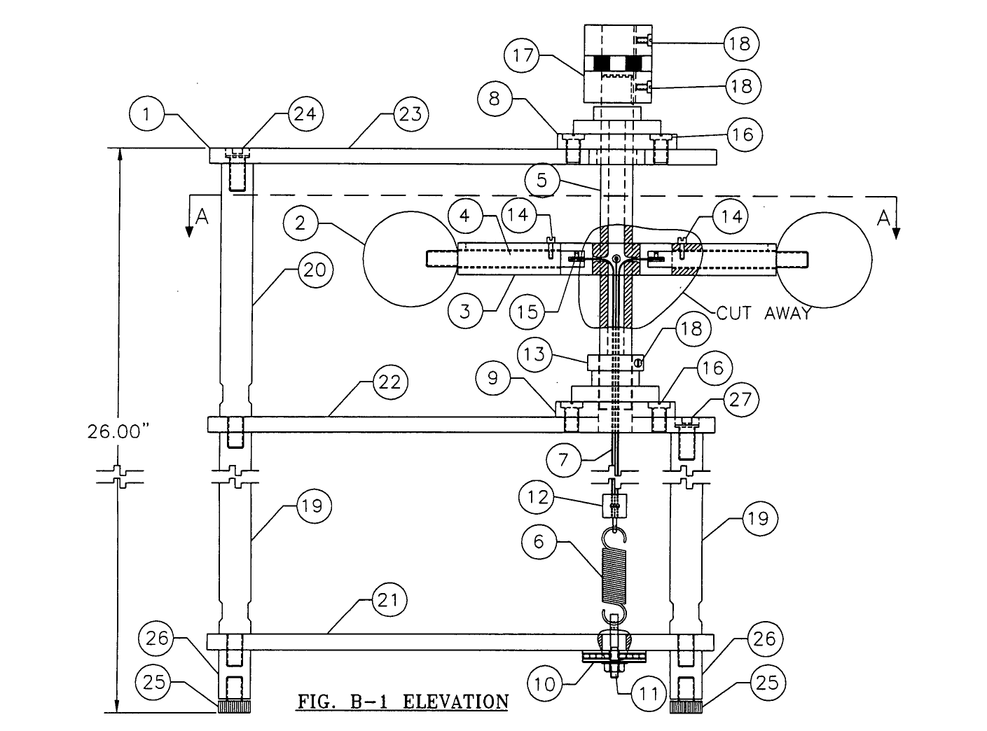

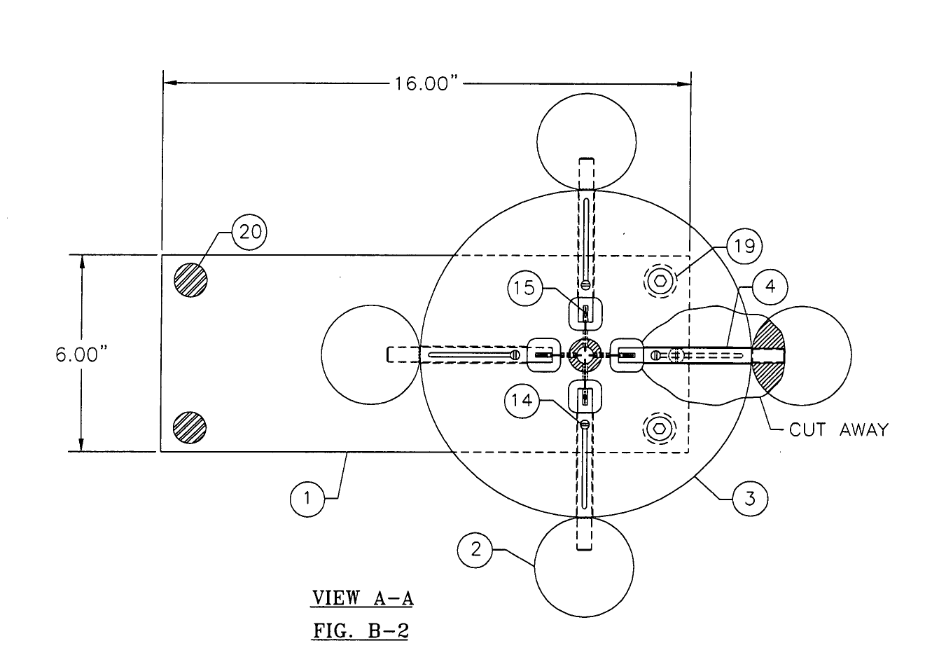

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Flywheels and other mechanical devices for conservation of kinetic energy.

### BRIEF SUMMARY OF INVENTION

An energy conservation flywheel with variable moment of inertia (a kinetic energy storage device) includes a flywheel in a shape of a top. From a disk, sliding rods with weights (mass) attached to one end sliding outward and inward (direction is from center of disk radially) during rotation hence creating variable moment of inertia. Sliding outward of rods/weights is caused by centrifugal forces. Sliding inward is achieved by a calibrated spring which is attached to other end of sliding rods. This device rotates in horizontal plane.

Energy conservation flywheel with variable moment of inertia (ECF-VMI) is using Variable moment of inertia to store kinetic energy more effectively and for longer period of time.

Efficiency may by further improved by placing this device in a vacuum canister and adding magnetic bearings.

‘ECF-VMI’ can be coupled with an electric generator in order to take over surplus energy, from a driving machine, when there is a low energy demand and use it during hours of peak demand.

“ECF-VMI” device can be proportionally expanded and designed to be any desired and/or required size.

### BRIEF DESCRIPTION OF THE SEVERAL VIEWS OF THE DRAWING

Figure A1 Is In Perspective View.

Figure B1 Is An Elevation View (Vertical Plane).

Figure B2 Is A Top View At Section A-A (Horizontal Plane).

### DETAILED DESCRIPTION OF INVENTION

1.0 The subject of this patent application is an energy conservation flywheel with variable moment of inertia (ECF-VMI). This apparatus is an assembly made up of three subassemblies, namely, of a steel frame (sf) a flywheel (fw) and a steel spring (ssp).

1.1 Subassembly (sf) consists of the following components:
Three rigid steel plates and are of rectangular shapes bolted together with supporting legs and bolts to form a shelf like steel frame.
Ball bearings are pre lubricated self-aligning machined ball bearings pillow blocks, square flange mount. They are fastened with bolts to a steel frame.
Revolving spring linkage is made up of a bottom part machine ball bearing-axially Loaded (screwed to a steel frame), tension bolt and nut and top part (linkage for a spring).

1.2 Subassembly (fw-top shape) consists of the following components:
A wheel/disk is made of steel plate, has four square openings near a disk center and four (fine surface) holes drilled from circumference to square openings, toward the center of disk (90 deg. apart). From square openings, also there are four smaller holes running toward a disk/shaft center.
Hollow shaft is of a hollow cylinder shape and is of steel make, it has four small holes (90 deg. apart) of fine surface.
A shaft collar is of a hollow cylinder shape, cut along cylinder height and has a setscrew.
A wheel/disk and a hollow shaft are joined together under compression thus making one integral part.
Steel spheres are of steel make and each one has a treaded hole in it.
Pistons/rods are of cylinder shape of steel make with fine surfaces. Each piston/rod has one end treaded, has a stopping pin at the other end and also has a hole run axially with a setscrew perpendicular to it.

1.3 Subassembly (ssp) consists of the following components:
A calibrated extension spring.
Four pieces of stainless steel cable (wire rope) and a wire rope clip.
Tension bolt and nut/revolving spring linkage.

1.1. Energy conservation flywheel with variable moment of inertia (ECF-VMI) principal of operation.
“ECF-VMI” will start to rotate after it receives initial spin, thru flexible or a detachable coupling (fc/dc), from any driving device. This driving device will be turned off and/or detached then the sum of moments of external forces acting about the axis of “ECF-VMI” is zero.
Initial centrifugal forces, created by rotation, will cause movable steel weights (mass) on sliding rods to start moving outward; mass moment of inertia of flywheel (fw) will start increasing while rotation and centrifugal forces will start decreasing. When centrifugal forces become equal to a steel spring (ssp) force stretched for a lent of weights travel, then at this point centrifugal forces and spring force will be in balance. After some time, rotation will start decreasing (so centrifugal forces & kinetic energy) therefore a spring force becomes greater than centrifugal forces hence will start to retract weights (mass moment of inertia is decreasing). When weights are retracted then rotation will start increasing while mass moment of inertia is decreasing (conservation of angular momentum), also centrifugal forces will start increasing thus pulling weights out. When centrifugal forces become equal to a spring (ssp) force again and after some time, rotation starts to decrease thus centrifugal forces start to decrease hence a spring (ssp) will start to retract weights inward. This increases rotation (conservation of angular momentum); increased rotation will cause increase of centrifugal forces (also kinetic energy) and so on process will continue to cycle. Now driving device can be turned or coupled on in order to use flywheel (fw) stored energy:
This device rotates in horizontal plane. Friction losses are neglected in the above explanation.
More efficient operation of this flywheel would be if magnetic bearings are used (instead machine bearings) and if it operates in a vacuum canister!
There is no size/mass limit of this device, and one can only imagine what magnitude of centrifugal forces, angular momentum and kinetic energy may be achieved with a right size and rotation.
Movable weights (mass) may be of different shape than a sphere.
1.2 Energy conservation flywheel with variable moment of inertia (ECF-VMI) device.
1.3 Flywheel (FW) in the shape of a top which consists of a disk and a hollow shaft. Disk is of rigid material (steel); has four bored (fine machined) 90 deg. apart holes (cylinders) from circumference toward center; also has four square cut-offs near the center equally spaced. Hollow shaft is of rigid material (steel) and it has four, perpendicular to a shaft axis, holes (fine machined). These holes have inlet/outlet bells.
1.4 The following assembly: a weight (mass), a fine machined piston/rod treaded on one side and has axial hole and two radial holes (treaded) on other side. Steel cables and cables clip, rotating spring mechanism (bearing and a tension bolt/nut).
Description Of Operation Of The Energy Conservation Flywheel With Variable Moment Of Inertia Model “ECF-VMI-01” (Shown On Drawings) And Is In Production. “ECF-VMI-01” will start to rotate after it receives initial spin, thru a flexible coupling and/or a detachable clutch (fc/dc), from any driving device. This driving device will be turned off and/or detached so then the sum of moments of external forces about the axis is zero. Let the initial (or point #1) spin be 52 rad/s (496 rpm), then mass moment of inertia will be 0.2116 (slug-ft²), centrifugal forces created by rotation and acting on spheres (ss/r) will be 750.4 lbs at this point. This will cause steel spheres/rods (ss/r) to start moving outward, mass moment of inertia will start increasing (at final or point #2 will be 0.3208 slug-ft²), rotation/centrifugal forces will be decreasing (34.3 rad/s or 327 rpm at point#2); kinetic energy will be decreasing also. At point #2 centrifugal forces (431.2 lbs) will become equal to the steel spring (ssp) force (431.2 lbs) stretched for a lent of the spheres/rods (ss/r) travel. Therefore centrifugal forces and a spring force will be in balance. Further rotation decreasing (so centrifugal forces) will cause spheres (ss/r) to start retracting under the spring (ssp) force. When this happen, rotation will start to increase (conservation of angular momentum) hence centrifugal forces will increase (kinetic energy too) also; (ss/r) will be moving outward until centrifugal forces become equal to the spring (ssp) force. Again, when rotation starts to decrease centrifugal forces will start to decrease hence the spring (ssp) will start to retract steel spheres (ss/r) in and thus mass moment of inertia will decrease but rotation will start increasing (conservation of angular momentum). Increased rotation will cause increase of centrifugal forces (also kinetic energy); the steal spheres (ss/r) will start moving outward and so on process will continue to cycle. Now driven device can be turned or coupled on in order to use “ECF-VMI-01” stored kinetic energy. This device rotates in horizontal plane. Friction loses are neglected in the above explanation. Sample Calculation of the Above Description of ECF-VMI-01 Steel Sphere (ss) Diameter D=3″; Radius r=1.5″; Steel density δ=490 lbs/ft³ Sphere volume V=4/3π r³=4/3×π×1.5³=14.14 in³=0.0082 ft³ Sphere weight w=Vδ=0.0082×490=4.0 lbs Sphere mass m=w/g=4.0/32.2=0.124 slugs, where g=32.2 ft/s²; slug=(lbs s²/ft) Mass moment of inertia of ‘ss’ Io=2/5mr² (slug-ft²) centroidal; Io=2/5×0.124×(1.5/12)²=0.000775 (slug-ft²) Sphere is 6.5″ away from axis initially, and then mass moment of inertia about axis (z) is, Izi=Io+mxi²=0.000775+0.124×(6.5/12)²=0.0372 (slug-ft²) Sphere is moving outward, farthest from axis (z) is 8.5″, and then mass moment of inertia is, Izf=Io+mxf²=0.000775+0.124×(8.5/12)²=0.063 (slug-ft²) There are 4 spheres, therefore Izi (4)=4×0.0372=0.149 (slug-ft²) Izf (4)=4×0.063=0.252 (slug-ft²) Wheel/Disk (w/d) Diameter D=10″; Radius r=5″; Thickness t=1″ Solid disk volume: V=r²πt (ft³); V=(5/12)²×π×(1/12)=0.04545 (ft³) Weight of solid disk: W=Vδ=0.04545×490=22.27 (lbs) Mass of solid disk: m=W/g=22.27/32.3=0.692 (slug) Mass moment of inertia of solid disk: Iy=Iz=1/2m r²=1/2×0.692×(5/12)²=0.06 (slug-ft²) Square openings a=1″; t=1″; W=Vδ=(1/12)²×(1/12)²×490=0.284 (lbs); Mass, m=0.284/32.2=0.0088 (slug) This opening is a negative weight (only air is there)! Also it is made slightly oval at corners but that is negligible! Mass moment of inertia-centroidal, Iyoi=1/6 m a²=1/6×0.0088×(1/12)²=0.00001 (slug-ft²) Mass moment of inertia with respect to ‘z’ (FW) axis, Izoi=Iyi+m(1.25/12)²=0.00001+0.0088××(1.25/12)²=0.000106 (slug-ft²) Then 4 openings have negative mass moment of inertia, Izo=4×0.000106=0.00042 (slug-ft²) Wheel/Disk with 4 openings has mass moment of inertia, Id=Iz−Izo=0.06−0.00042=0.0596 (slug-ft²) Piston/Steel (p/s), Slender Rod Diameter, d=0.5″; r=0.25″; Length, 1=4″; Actual is 5″ but 1″ of it is treaded and screwed into a sphere therefore only 4″ length is used to calculate this rod mass moment of inertia. Weight, W=r²π lδ=0.25²××(4/12)×490=0.223 (lbs); Mass m (rod)=W/g=0.223/32.2=0.0069 (slug) Iypi=1/2m (3r²+l²)=½×0.0069×(3×0.25/12+4²/12²)=0.0006 (slug-ft²) Rod center is 3″ from axis ‘z’ initially, then; Iyi=Iypi+m(3/12)²=0.0006+0.0069×(3/12)²=0.00103 (slug-ft²) The rod is moving outward, during rotation, to 5″ final from ‘z’ axis (there is a stop pin), then Iyf=Iypi+m(5/12)²=0.0006+0.0069×(5/12)²=0.0018 (slug-ft²) There are 4 rods. Initial centroid of the Sphere/Rod (s/r) Assembly (From ‘z’ axis); xi=(0.124×6.5″+0.0069×3″)/(0.124+0.0069)=6.32″=0.53 ft. Sphere/Rod assembly mass moment of inertia; Is/r=Io+Iyi=0.000775+0.0006=0.00137 (slug-ft²) Initial Mass Moment Of Inertia Of S/R (Point-1); Is/ri=Is/r+(mo+mr)xi²=0.00137+(0.124+0.0069)×0.532=0.038 (slug-ft²) For 4 s/r; Is/ri=4×0.038=0.152 (slug-ft²) Final Mass Moment Of Inertia Of S/R (Point-2); S/R Assembly is moving outward to final (Point-2) position; Final centroid of S/R Assembly from ‘z’ axis; x2=0.53′+(2″/12)′=0.7 ft. Then final (Point-2) s/r mass moment of inertia; Is/rf=Is/r+(mo+mr)×2²=0.00137+(0.124+0.0069)×0.7²=0.0655 (slug-ft²) For 4-S/R; Is/rf=4×0.0655=0.262 (slug-ft²) Initial mass moment of inertia of ‘FW’ (Point-1): Ii=Is/ri+Id=0.152+0.0596=0.2116 (slug-ft²) Final mass moment of inertia of ‘FW’ (Point-2): If=Is/rf+Id=0.262+0.0596=0.3216 (slug-ft²) Energy Conservation After initial spin no external moments act on the system (fw) hence there is conservation of angular momentum, and then Ii×ωi=If×ωf Initial angular momentum (Point-1) when ‘fw’ rotates at 52 (rad/sec) or 496 rpm is Ii×ωi=0.2116×52=11.0 (lbs-s-ft) Then from final angular momentum (Point-2), ωf=Ii×ωi/If=11.0/0.3216=34.2 (rad/sec) or 327 rpm. Centrifugal Forces ΣFn=man (lbs); an=rω² One sphere/rod assembly: Fs/r=man=mr ω² (lbs), where m=ms+mr=0.124+0.0069=0.1309 slug. At point #1 (Initial); ri=0.53Ft & ωi=52 (rad/s) then, Fs/ri=0.1309×0.53×52²=187.6 (lbs), For four assemblies: 750.4 (lbs) At point #2 (Final); r2=0.7Ft & ωf=34.2 (rad/s) then, Fs/rf=0.1309×0.7×34.2²=107.2 (lbs), For four assemblies: 428.8 (lbs) These forces will transfer vertically by steel cables to an extension spring. Required an extension spring to balance out this force while extended 2″. Tangential Forces ΣFt=mr α Only tangential forces acting on ‘fw’ are frictional in bearings and air friction. Calculation of these is complex and would take lot of space so I skip it for now. ΣMo=Ioα (about mass center and axis ‘z’ of rotation.) Flywheel rotates in horizontal plane therefore g-force acts normally to horizontal plane. Kinetic Energy At point#1, T1=½Iiωi²=½×0.2116×52²=286.1 (lbs-ft), stored energy initially. At point#2, T2=½Ifψf²=½×0.3216×34.2²=188.1 (lbs-ft), stored energy decreased, at final point (spheres are farthest from ‘z’ axis), since rotation decreased. Spheres are being retracted because of decreased centrifugal forces. Now starts recovery of kinetic energy since rotation increases!
